(19) United States
(12) Patent Application Publication
(10) Pub. No.: US 2026/0355551 A1
(43) Pub. Date: Nov. 12, 2026

(54) FALL ARREST CONNECTING DEVICE

(71) Applicant: YOKE INDUSTRIAL CORP., Taichung City (TW)

(72) Inventors: WEI-CHIEH HUNG, Taichung City (TW); YA-CHUN CHENG, Changhua County (TW)

(73) Assignee: YOKE INDUSTRIAL CORP., Taichung City (TW)

(21) Appl. No.: 19/315,873

(22) Filed: Sep. 2, 2025

(30) Foreign Application Priority Data
May 9, 2025 (TW) 114117541

(51) Int. Cl. A62B 35/00

(52) U.S. Cl. CPC A62B 35/0037

(57) ABSTRACT

A fall arrest connecting device includes a hanging seat having a horizontal rod and two lateral rods respectively connected to two sides of the horizontal rod. Each lateral rod includes a rod portion and a sleeve connected to the rod portion. A through hole is formed in the sleeve. A latch seat is formed on a surface of the rod portion and the sleeve of one of the lateral rods and is engaged with a movable catch. A communicating hole communicating with the through hole is formed at the latch seat. An engaging portion of the catch extends through the communicating hole into the through hole. A movable latch detachably passes through the through holes of the lateral rods and has a latch shaft with an engaged groove for engaging with the engaging portion, thereby securing a position of the movable latch along an axial direction of the latch shaft.

### BACKGROUND OF THE INVENTION

### TECHNICAL FIELD

The present invention relates generally to a connecting device for fall prevention device, and more particularly to a fall arrest connecting device.

### DESCRIPTION OF RELATED ART

A conventional fall arrest connecting device, for example, Taiwan Utility Model Patent No. M506176 titled “Fall Arrest Connecting Device”, includes a hanging seat, a movable latch, a first control group, and a second control group. During using the convention fall arrest connecting device, the movable latch passes through a wearable harness and a first hole and a second hole of the hanging seat, the movable latch closes an opening of the hanging seat, and the hanging seat is configured to hang a lifting lug of a fall arrest device. The hanging seat has the first control group. A shaft has the second control group. The first control group and the second control group respectively determine whether the movable latch is axially movable for opening the opening of the hanging seat.

The conventional fall arrest connecting device is provided with the first control group and the second control group, and the first control group and the second control group are simultaneously manipulated in order to axially move the movable latch and open the opening of the hanging seat. However, during operation, as a position of the first control group is not close to the hand of the user that holds the hanging seat, the first control group could not be simultaneously operated with the hand holding the hanging seat, which causes inconvenience in use.

### BRIEF SUMMARY OF THE INVENTION

In view of the above, the primary objective of the present invention is to provide a fall arrest connecting device, wherein a catch is configured to fix a movable latch, and the catch is disposed on a hanging seat, so that a user could simultaneously hold the hanging seat and operate the catch to release the movable latch with the same hand, thereby providing convenience to the user.

The present invention provides a fall arrest connecting device, including a hanging seat, a catch, and a movable latch. The hanging seat has a horizontal rod. Two lateral rods are respectively connected to two ends of the horizontal rod. A recess is formed between the two lateral rods and the horizontal rod. The recess has an opening. Each of the two lateral rods includes a rod portion and a sleeve. The rod portion is connected to the horizontal rod. The sleeve is connected to an end of the rod portion away from the horizontal rod. The sleeve has a through hole. The two through holes of the two lateral rods face each other and are respectively located on two sides of the opening. A latch seat is formed on a surface of one of the two lateral rods. A side of the latch seat is connected to the sleeve of the corresponding lateral rod. Another side of the sleeve is connected to the rod portion of the corresponding lateral rod. A communicating hole is formed at a portion of the latch seat connected to the sleeve of the corresponding lateral rod. The communicating hole communicates with the through hole of the corresponding lateral rod.

The catch is engaged with the latch seat and is movable between a locked position and a released position. The catch has an engaging portion. When the catch is located at the locked position, the engaging portion extends through the communicating hole and into the through hole of the corresponding lateral rod. When the catch is located at the released position, the engaging portion moves out of the communicating hole. The movable latch has a latch shaft. The latch shaft detachably passes through the two through holes of the two lateral rods to close the opening. An engaged groove is formed on an outer peripheral surface of the latch shaft. The engaged groove directly faces the communicating hole. The engaging portion of the catch is engaged with the engaged groove, thereby securing a position of the movable latch along an axial direction of the latch shaft.

When the present invention is used, the movable latch passes through a wearable harness, and the hanging seat is configured to hand a lifting lug of a fall arrest device. When the opening of the hanging seat is required to open, the user could operate the catch to move from the locked position to the released position, so that the engaging portion is no longer in the state of engaging with the engaged groove, thereby releasing the movable latch; therefore, the movable latch could move along the axial direction and open the opening of the hanging seat. With the aforementioned design, the latch seat on which the catch is disposed is connected to the sleeve and the rod portion of one of the lateral rods, so that the position of the catch is close to the hanging seat and therefore, the hand of the user could simultaneously hold the hanging seat and operate the catch, thereby providing convenience in using.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the fall arrest connecting device according to an embodiment of the present invention;

FIG. 2 is an exploded view of the fall arrest connecting device according to the embodiment of the present invention;

FIG. 3 is a side view of the fall arrest connecting device in FIG. 1;

FIG. 4 is a sectional view along the 4-4 line in FIG. 3;

FIG. 5 is a sectional view along the 5-5 line in FIG. 3;

FIG. 6 is a schematic view, showing that the catch in FIG. 5 is pressed;

FIG. 7 is a schematic view, showing that the catch and the button are simultaneously pressed; and

FIG. 8 is a schematic view, showing that the movable latch is removed to open the opening of the hanging seat.

### DETAILED DESCRIPTION OF THE INVENTION

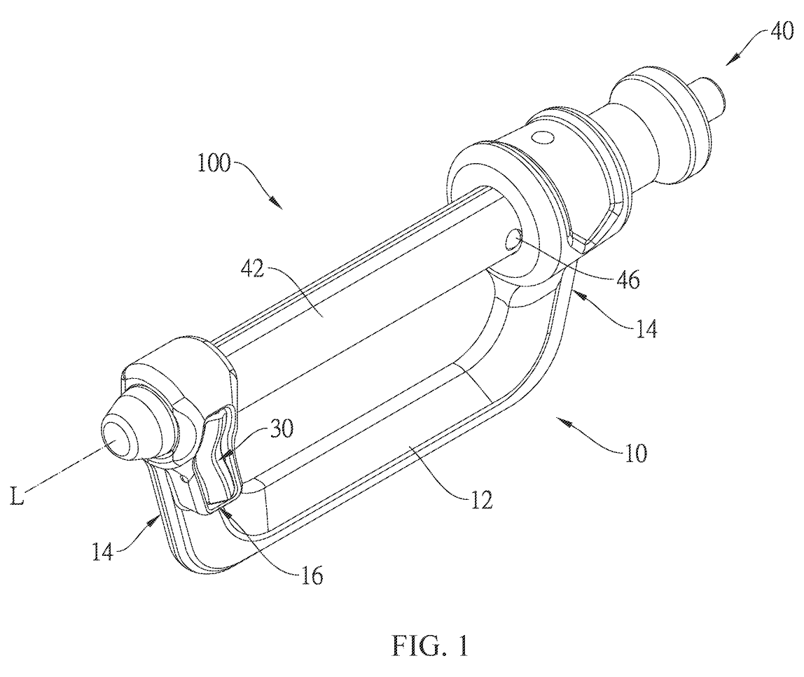

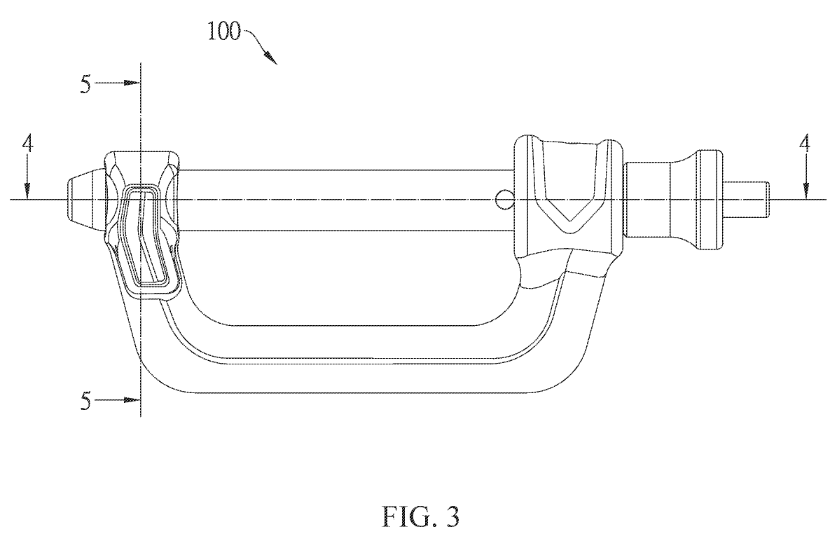

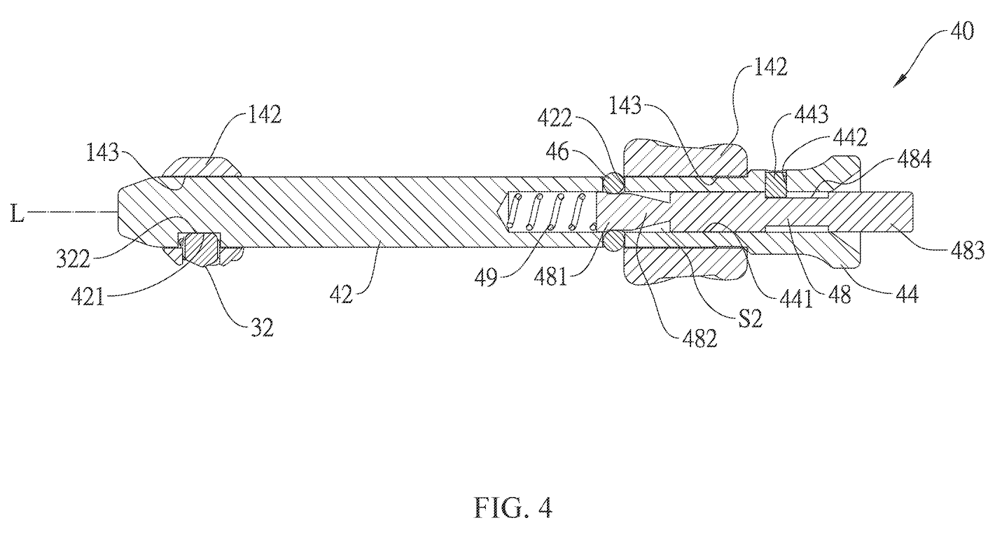

A fall arrest connecting device 100 according to an embodiment of the present invention is illustrated in FIGS. 1 to 5. During using, the fall arrest connecting device 100 is fixed to a wearable harness and is configured to hang a lifting lug of a fall arrest device. In the following description of the structure of the fall arrest connecting device 100, a top-bottom direction and a left-right direction are defined based on the orientation of the fall arrest connecting device 100 when a user positions the fall arrest connecting device 100 on a wearable harness and faces the fall arrest connecting device 100. The fall arrest connecting device 100 includes a hanging seat 10, a locking assembly 30, and a movable latch 40.

The hanging seat 10 includes a horizontal rod 12. The horizontal rod 12 is a straight rod extending along the left-right direction. Two lateral rods 14 are respectively connected to a left end and a right end of the horizontal rod 12. A recess S is formed between the two lateral rods 14 and the horizontal rod 12. The recess S has an opening S1. Each of the two lateral rods 14 includes a rod portion 141 and a sleeve 142. The two rod portions 141 of the two lateral rods 14 are respectively connected to the right end and the right end of the horizontal rod 12. The sleeve 142 of each of the lateral rods 14 is connected to an end of the corresponding rod portion 141 away from the horizontal rod 12, i.e., a top end of the corresponding rod portion 141. The sleeve 142 has a through hole 143. The two through holes 143 of the two lateral rods 14 face each other and are respectively located on two sides of the opening S1.

A latch seat 16 is formed on a front surface of the left lateral rod 14. The latch seat 16 is a base approximately extending along the top-bottom direction. A top side and a bottom side of the latch seat 16 are respectively connected to the left sleeve 142 and the left rod portion 141. More specifically, the latch seat 16 includes a locking groove 161 and an annular wall 162. The annular wall 162 surrounds the locking groove 161. A communicating hole 163 is formed at a portion of the latch seat 16 connected to the left sleeve 142. The communicating hole 163 communicates with the locking groove 161 and the left through hole 143. A spring seat 164 is formed at a portion of the locking groove 161 connected to the left rod portion 141. The spring seat 164 is a circular recess.

The locking assembly 30 includes a catch 32, a shaft 34, and a compression spring 36. The catch 32 is an elongated body corresponding to a shape of the locking groove 161. The catch 32 is engaged with the latch seat 16 and is movable between a locked position P1 and a released position P2. When the catch 32 is at a normal state and is not subjected to an external force, the catch 32 is located at the locked position P1. More specifically, the catch 32 is placed in the locking groove 161, and a middle of the catch 32 has a shaft hole 321. Two locking holes 1621 are respectively formed on two opposite sides of the annular wall 162 and are respectively located on a left side and a right side of a position of the shaft hole 321.

A middle of the shaft 34 pivotally passes through the shaft hole 321 of the catch 32. Two ends of the shaft 34 are respectively fixed in the two locking holes 1621. A top side of the catch 32 facing the latch seat 16 protrudes to form an engaging portion 322. The engaging portion 322 extends through the communicating hole 163 and into the left through hole 143. At that time, the catch 32 is located at the locked position P1.

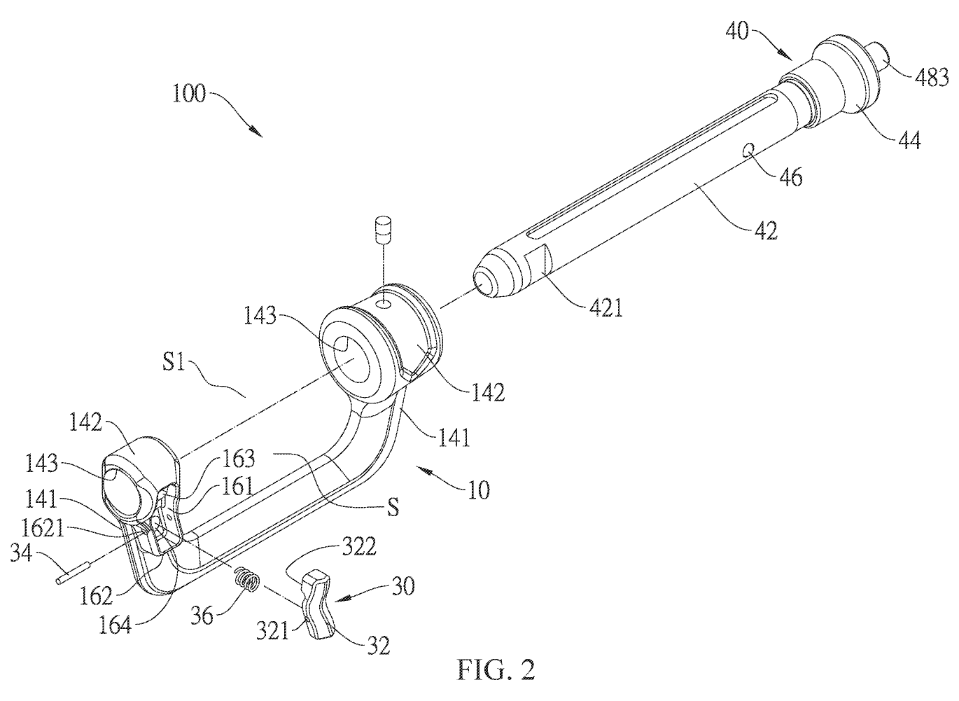

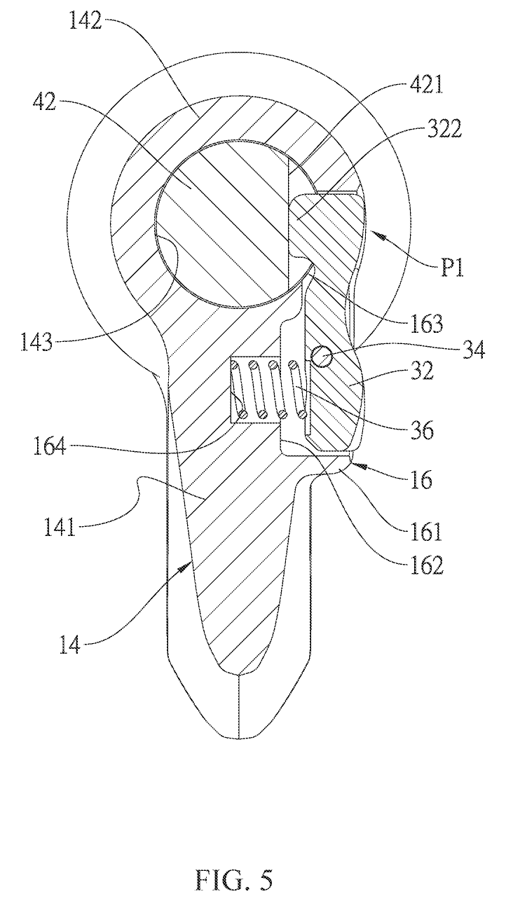

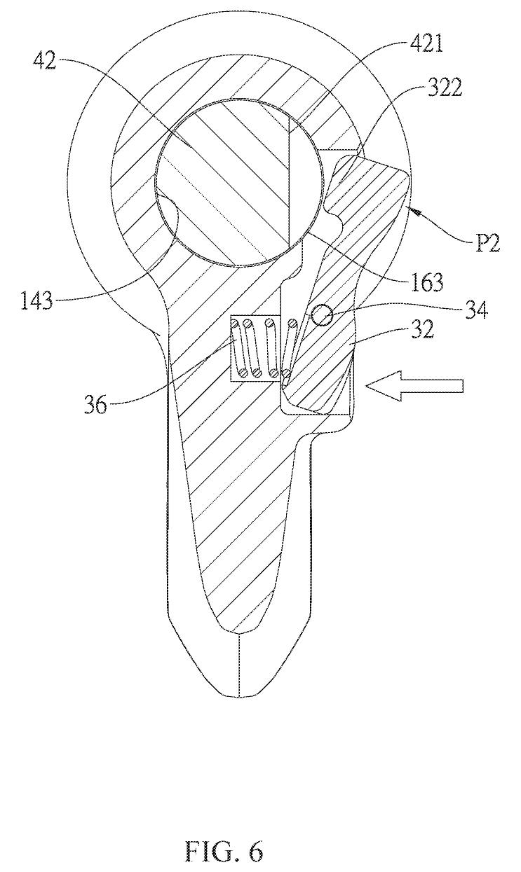

The compression spring 36 is disposed in the spring seat 164. The compression spring 36 abuts against another side of the catch 32 opposite to the engaging portion 322, i.e., a bottom side of the catch 32. The compression spring 36 continuously pushes the bottom side of the catch 32, so that when the catch 32 is at the normal state that is not subjected to pressing by the external force, the engaging portion 322 keeps passing through the communicating hole 163 and into the left through hole 143. Referring to FIG. 2, FIG. 5, and FIG. 6, when the user presses the bottom side of the catch 32, the catch 32 rotates around the shaft 34, which is located at the middle of the catch 32, so that the top side of the catch 32 moves outwards, thereby moving the engaging portion 322 out of the communicating hole 163; at that time, the catch 32 is located at the released position P2. With the aforementioned design, the user could simultaneously hold the hanging seat 10 and press the bottom side of the catch 32 with the same hand. By pressing the bottom side of the catch 32, the catch 32 is changed from the locked position P1 to the released position P2.

The movable latch 40 includes a latch shaft 42 and a head 44. The latch shaft 42 is a straight rod extending along the left-right direction. An extension direction of a central line of the latch shaft 42 is defined as an axial direction L. The latch shaft 42 detachably passes through the two through holes 143. The latch shaft 42 passes through the left sleeve 142 and the right sleeve 142 to close the opening S1, so that the latch shaft 42 restricts objects, such as the lifting lug of the fall arrest device, from entering or exiting the opening S1. More specifically, a right-end portion of the latch shaft 42 passes through the right through hole 143. A left-end portion of the latch shaft 42 passes through the left through hole 143. An engaged groove 421 is formed on an outer peripheral surface of the left-end portion of the latch shaft 42 and corresponds to a position of the communicating hole 163. A position of the engaged groove 421 is aligned with the communicating hole 163, so that when the engaging portion 322 of the catch 32 extends into the left through hole 143, the engaging portion 322 is engaged with the engaged groove 421 of the latch shaft 42. In this way, the catch 32 secures a position of the movable latch 40 along the axial direction L, so that the latch shaft 42 is maintained in a state of closing the opening S1.

The head 44 is connected to a right end of the latch shaft 42. The head 44 abuts against an outer side of the right sleeve 142. A button groove 441 is formed at a middle of an outer-end surface of the head 44. The button groove 441 is an elongated groove extending along the axial direction L of the latch shaft 42. An inner end of the button groove 441 is a closed end and extends into the latch shaft 42. Two engaged holes 422 are respectively formed on two sides of an outer peripheral surface of the latch shaft 42. Each of the engaged holes 422 is adjacent to the right-end portion of the latch shaft 42. Each of the engaged holes 422 communicates with the button groove 441. Two engaging members 46 are respectively disposed in the two engaged holes 422. Each of the engaging members 46 is a spherical body. A part of each of the engaging members 46 protrudes from a surface of the latch shaft 42 and is engaged with an inner side of the right sleeve 142.

A button 483 is disposed on the head 44 and is configured to control whether each of the engaging members 46 is in a protruding state or in a retracting state. More specifically, an operating shaft 48 passes through the button groove 441. The operating shaft 48 has a column portion 481 and a conical portion 482. An outer peripheral surface of the column portion 481 abuts against the two engaging members 46. A receiving space S2 is formed on an outer peripheral surface of the conical portion 482 and is configured to receive another part of each of the engaging members 46. An outer end of the operating shaft 48 protrudes out of the outer-end surface of the head 44. The button 483 is formed at an outer-end portion of the operating shaft 48. A restoring spring 49 is disposed between an inner end of the operating shaft 48 and the inner end of the button groove 441. In this way, after the button 483 is pressed by the user and then is released, the restoring spring 49 pushes the operating shaft 48 and the button 483 back to an original position. At that time, the column portion 481 of the operating shaft 48 could return to a position of pushing the part of each of the engaging members 46 out of one of the engaged holes 422.

A positioning groove 484 is formed on an outer peripheral surface of a part of the operating shaft 48 located in the head 44. The positioning groove 484 is an elongated groove extending along the axial direction L of the latch shaft 42. A positioning hole 442 is formed on an outer peripheral surface of the head 44. The positioning hole 442 communicates with the button groove 441. The positioning hole 442 is engaged with a positioning pin 443. An inner end of the positioning pin 443 extends into the positioning groove 484 and confines a movement range of the operating shaft 48 along the axial direction L. When the button 483 is not pressed, the column portion 481 of the operating shaft 48 controls the engaging members 46 to protrude out of the surface of the latch shaft 42. When the button 483 is pressed, the operating shaft 48 is driven to make the column portion 481 leave a position of abutting against the two engaging members 46 and to move the conical portion 482 to an inner side of the two engaged holes 422, so that the engaging members 46 are released and respectively retract into the two engaged holes 422.

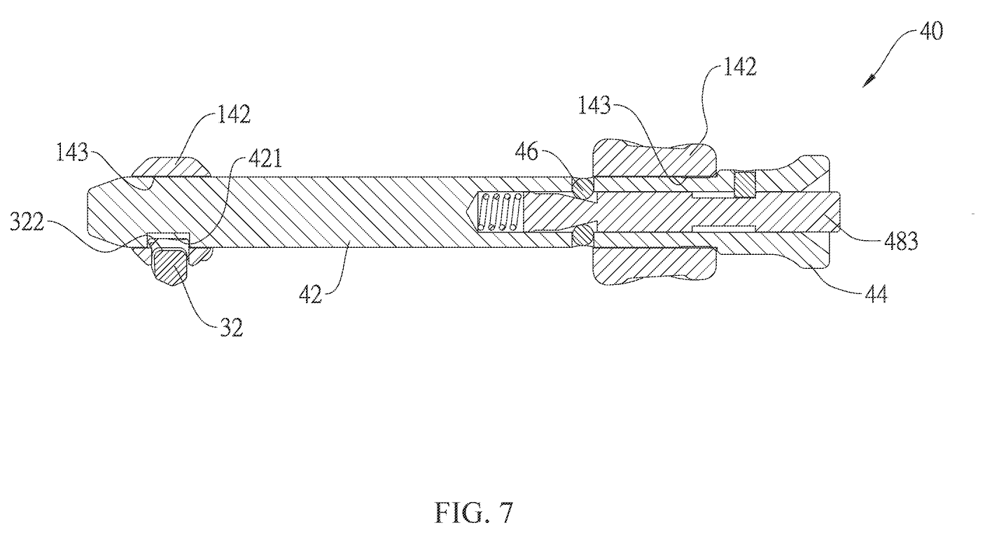

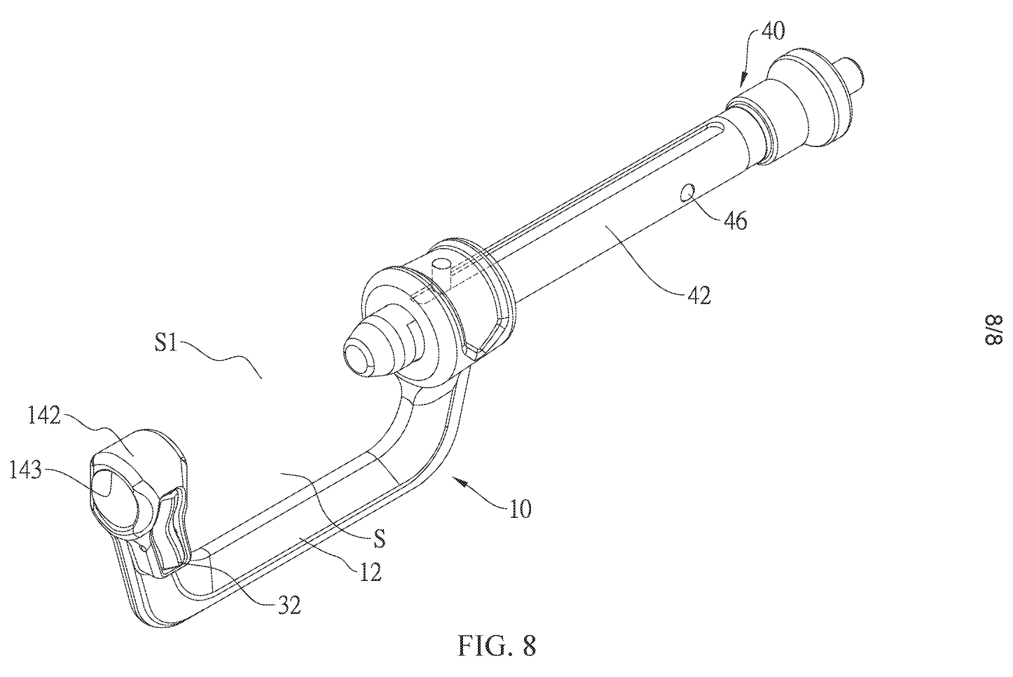

Referring to FIG. 1, when the fall arrest connecting device 100 according to the embodiment of the present invention is used, the movable latch 40 passes through the wearable harness, and the horizontal rod 12 and the two lateral rods 14 of the hanging seat 10 are configured to hang the lifting lug of the fall arrest device. Referring to FIG. 7 and FIG. 8, when the opening S1 of the hanging seat 10 is required to open, the user could press the bottom side of the catch 32, so that the engaging portion 322 is no longer in a state of engaging with the engaged groove 421, thereby releasing the movable latch 40. At the same time, the user presses the button 483, so that the engaging members 46 are not engaged with the inner side of the right sleeve 142. As the catch 32 and the engaging members 46 no longer restrict the axial movement of the movable latch 40, the movable latch 40 could be pulled out from the right at that time, so that the latch shaft 42 leaves the left through hole 14 and the opening S1 is opened by the movable latch 40. Referring to FIG. 2, as the latch seat 16 on which the catch 32 is disposed is connected to the left sleeve 142 and the left rod portion 141, a position of the catch 32 is close to a position of the hanging seat 10, so that when the user operates the catch 32, the hand of the user could simultaneously hold a left side of the hanging seat 10 and press the catch 32 with the thumb to release the movable latch 40, thereby providing convenience in using and releasing the movable latch 40.

In the current embodiment, the latch seat 16 is formed on the front surface of the left lateral rod 14, and the locking assembly 30 is mounted to the latch seat 16, so that the catch 32 is provided with the function of locking the movable latch 40. In other embodiments, a position of the latch seat 16 could be changed; the latch seat 16 could be formed on a front surface of the right lateral rod 14, and the locking assembly 30 is engaged with the right latch seat 16; at the same time, the engaged groove 421 of the latch shaft 42 is changed from being disposed on the outer peripheral surface of the left-end portion of the latch shaft 42 to being disposed on an outer peripheral surface of a right-end portion of the latch shaft 42. In this way, the engaged groove 421 is still aligned with the communicating hole 163 of the latch seat 16, so that the engaging portion 322 of the catch 32 could pass through the communicating hole 163 to be engaged with the engaged groove 421 and fix the position of the movable latch 40 along the axial direction L, thereby maintaining the latch shaft 42 in the state of closing the opening S1.

It must be pointed out that the embodiment described above is only a preferred embodiment of the present invention. All equivalent structures which employ the concepts disclosed in this specification and the appended claims should fall within the scope of the present invention.

What is claimed is:

1. A fall arrest connecting device, comprising:
a hanging seat, having a horizontal rod, wherein two lateral rods are respectively connected to two ends of the horizontal rod; a recess is formed between the two lateral rods and the horizontal rod; the recess has an opening; each of the two lateral rods comprises a rod portion and a sleeve; the rod portion is connected to the horizontal rod; the sleeve is connected to an end of the rod portion away from the horizontal rod; the sleeve has a through hole; the two through holes of the two lateral rods face each other and are respectively located on two sides of the opening; a latch seat is formed on a surface of one of the two lateral rods; a side of the latch seat is connected to the sleeve of the corresponding lateral rod; another side of the latch seat is connected to the rod portion of the corresponding lateral rod; a communicating hole is formed at a portion of the latch seat connected to the sleeve of the corresponding lateral rod; the communicating hole communicates with the through hole of the corresponding lateral rod;
a catch, engaged with the latch seat and movable between a locked position and a released position, wherein the catch has an engaging portion; when the catch is located at the locked position, the engaging portion extends through the communicating hole and into the through hole of the corresponding lateral rod; when the catch is located at the released position, the engaging portion moves out of the communicating hole; and
a movable latch, having a latch shaft, wherein the latch shaft detachably passes through the two through holes of the two lateral rods to close the opening; an engaged groove is formed on an outer peripheral surface of the latch shaft; the engaged groove directly faces the communicating hole; the engaging portion of the catch is engaged with the engaged groove, thereby securing a position of the movable latch along an axial direction of the latch shaft.

2. The fall arrest connecting device as claimed in claim 1, wherein the latch seat has a locking groove; the catch is placed in the locking groove; a middle portion of the catch is rotatably engaged with the latch seat; a spring seat is formed at the locking groove; a compression spring is disposed in the spring seat; the compression spring abuts against a side of the catch opposite to the engaging portion.

3. The fall arrest connecting device as claimed in claim 1, wherein the latch seat comprises a locking groove and an annular wall; the annular wall surrounds the locking groove; the communicating hole communicates with the locking groove and the through hole of the corresponding lateral rod; a spring seat is formed at a portion of the locking groove connected to the rod portion; the catch is placed in the locking groove and a middle of the catch has a shaft hole; two locking holes are respectively formed on two opposite sides of the annular wall; a shaft pivotally passes through the shaft hole; two ends of the shaft are respectively fixed in the two locking holes; the engaging portion is formed on a side of the catch facing the communicating hole; a compression spring is disposed in the spring seat; the compression spring abuts against another side of the catch opposite to the engaging portion.

4. The fall arrest connecting device as claimed in claim 1, wherein two engaged holes are respectively formed on two sides of the outer peripheral surface of the latch shaft; two engaging members are respectively disposed in the two engaged holes; a part of each of the two engaging members protrudes from a surface of the latch shaft and is engaged with an inner side of the sleeve of one of the two lateral rods; an end of the latch shaft is connected to a head; the head abuts against an outer side of the sleeve of the corresponding lateral rod; a button is disposed on the head and is configured to control whether each of the two engaging members is in a protruding state or in a retracting state; when the button is pressed, each of the two engaging members is released and retracts into one of the two engaged holes.

5. The fall arrest connecting device as claimed in claim 4, wherein a button groove is formed at a middle of an outer-end surface of the head; the button groove is an elongated hole extending along the axial direction of the latch shaft; an inner end of the button groove is a closed end and extends into the latch shaft; an inner end of each of the two engaged holes communicates with the button groove; an operating shaft passes through the button groove; the operating shaft has a column portion and a conical portion; an outer peripheral surface of the column portion abuts against the two engaging members; a receiving space is formed on an outer peripheral surface of the conical portion and is configured to receive another part of each of the two engaging members; a restoring spring is disposed between an inner end of the operating shaft and the inner end of the button groove; an outer end of the operating shaft extends out of the head; the button is formed on an outer-end portion of the operating shaft; when the button is pressed, the column portion is driven to leave a position of abutting against the two engaging members and to release the two engaging members, and the conical portion is driven to move to an inner side of each of the two engaged holes, thereby enabling each of the two engaging members to retract into one of the two engaged holes.

6. The fall arrest connecting device as claimed in claim 5, wherein a positioning hole is formed on an outer peripheral surface of the head; the positioning hole communicates with the button groove; a positioning groove is formed on an outer peripheral surface of the operating shaft; the positioning groove is an elongated groove extending along the axial direction of the latch shaft; the positioning hole is engaged with a positioning pin; an inner end of the positioning pin extends into the positioning groove.
